(19) United States
(12) Patent Application Publication
(10) Pub. No.: US 2026/0154320 A1
(43) Pub. Date: Jun. 4, 2026

(54) METHOD AND SYSTEM FOR AUTOMATICALLY GENERATING ONTOLOGIES FROM DOMAIN-SPECIFIC DOCUMENTS

(71) Applicant: LTI Mindtree Ltd, Mumbai (IN)

(72) Inventors: Brijesh Prabhakar, Mumbai (IN); ChandiPrasad Ojha, Mumbai (IN); Sagar Pise, Mumbai (IN)

(21) Appl. No.: 19/169,012

(22) Filed: Apr. 3, 2025

(30) Foreign Application Priority Data
Dec. 4, 2024 (IN) 202421095651

(51) Int. Cl. G06F 16/36; G06F 16/353; G06F 21/62

(52) U.S. Cl. CPC G06F 16/367; G06F 16/353; G06F 21/6245

(57) ABSTRACT

A method and system for automatically generating ontologies from domain-specific documents is disclosed. Domain-specific documents from multiple data sources are processed to generate normalized documents by performing at least one of extracting text from the domain-specific documents, removing textual noise from the extracted text, and standardizing a format of the extracted text. The normalized documents are distributed to a task queue to enable parallel processing across multiple processing units, which analyzes content within the normalized documents using natural language and generative AI techniques to extract domain-specific entities, entity relationships between the domain-specific entities, and entity properties associated with the domain-specific entities. A subject-predicate-object formatted data is generated based on the extracted domain-specific entities, the extracted entity relationships, and the extracted entity properties, to construct an ontology. The ontology is validated by verifying completeness of entity relationships and entity properties and is exported in a knowledge representation format.

### FIELD

Various embodiments of the present disclosure generally relate to generating ontologies. More particularly, the disclosure relates to a method and system for automatically generating ontologies from domain-specific documents.

### BACKGROUND

Knowledge graphs are increasingly important in various fields including artificial intelligence, data analytics, and information management. A fundamental component in knowledge graph creation is the development of ontologies, which provide structured frameworks defining relationships and entities within specific domains. These ontologies serve as the foundation for representing domain knowledge and enabling advanced data processing capabilities.

The development of comprehensive ontologies presents several technical challenges. Domain-specific documents, which contain valuable unstructured information, often include complex terminology, concepts, and relationships unique to particular fields. These documents may exist in various formats and contain intricate interconnections that must be accurately captured while maintaining semantic precision.

The scale and complexity of modern data ecosystems introduce additional technical considerations. As domains evolve and new information emerges, the volume and variety of documents containing relevant information continue to grow exponentially. This growth necessitates approaches that can efficiently process and validate large-scale datasets while maintaining consistency in knowledge representation.

Furthermore, regulatory requirements introduce technical constraints in ontology development. Regulatory frameworks such as those governing Personally Identifiable Information (PII), Payment Card Information (PCI), and Protected Health Information (PHI) impose stringent requirements for identifying, managing, and securing sensitive data. When sensitive data is improperly identified or inadequately tagged within an ontology, it not only compromises the quality and utility of the resulting knowledge graph but also exposes organizations to significant compliance violations and data security risks.

A major drawback of existing practices is the absence of a well-defined and certified ontology that serves as a ground truth for validating the quality and accuracy of the resulting knowledge graphs. Without such a standardized foundation, knowledge graphs may suffer from inconsistencies, inaccuracies, or gaps in representation, leading to inefficiencies in their application. This is particularly problematic for industries and domains that depend on precise and reliable knowledge representations to drive innovation and decision-making.

The combination of these technical factors-the complexity of domain-specific information, the scale of modern datasets, and the need for regulatory compliance presents significant technical challenges in ontology development. Addressing these challenges while maintaining efficiency and accuracy in knowledge representation constitutes an important technical problem in the field of knowledge graphs.

### SUMMARY

A method and system for automatically generating ontologies from domain-specific documents is disclosed. Domain-specific documents from multiple data sources are preprocessed to generate normalized documents by performing at least one of extracting text from the domain-specific documents, removing textual noise from the extracted text, and standardizing a format of the extracted text. The normalized documents are distributed to a task queue to enable parallel processing across multiple processing units, which analyzes content within the normalized documents using natural language processing techniques and generative AI techniques to extract domain-specific entities, entity relationships between the domain-specific entities, and entity properties associated with the domain-specific entities. A subject-predicate-object (SPO) formatted data is then generated based on the extracted domain-specific entities, the extracted entity relationships, and the extracted entity properties, to construct an ontology. The ontology is validated by verifying completeness of entity relationships and entity properties and is exported in a knowledge representation format.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

FIG. 1 is a diagram that illustrates an exemplary environment within which various embodiments of the present disclosure may function.

FIG. 2 is a diagram that illustrates the system for automatically generating ontologies from domain-specific documents, in accordance with an embodiment of the disclosure.

FIG. 3 is a diagram that illustrates a flow chart for a method for automatically generating ontologies from domain-specific documents, in accordance with an embodiment of the disclosure.

### DESCRIPTION

Pursuant to various embodiments, the method and system enables automatic generation of ontologies from domain-specific documents. Domain-specific documents from multiple data sources are preprocessed to generate normalized documents by performing at least one of extracting text from the domain-specific documents, removing textual noise from the extracted text, and standardizing a format of the extracted text. The normalized documents are distributed to a task queue to enable parallel processing across multiple processing units, which analyzes content within the normalized documents using natural language processing techniques and generative AI techniques to extract domain-specific entities, entity relationships between the domain-specific entities, and entity properties associated with the domain-specific entities. A subject-predicate-object (SPO) formatted data is then generated based on the extracted domain-specific entities, the extracted entity relationships, and the extracted entity properties, to construct an ontology. The ontology is validated by verifying completeness of entity relationships and entity properties and is exported in a knowledge representation format.

In one or more embodiments, an ontology is generated by formalizing the knowledge within a specific domain, where the system identifies and organizes key concepts (entities), their attributes, and the relationships between them. The ontology defines classes representing general concepts, instances that correspond to specific examples, properties that capture attributes or relationships, and rules that specify how the concepts interact.

In one or more embodiments, domain-specific documents refer to documents that contain information relevant to a particular field of industry, and they often include terminology, concepts, and relationships unique to that domain. Examples of domain specific documents include, Research Papers and Journals, Technical Manuals, Legal Documents, Industry Reports, Medical Records, Policy Documents, Product Specifications, whitepapers, instructional content, etc.

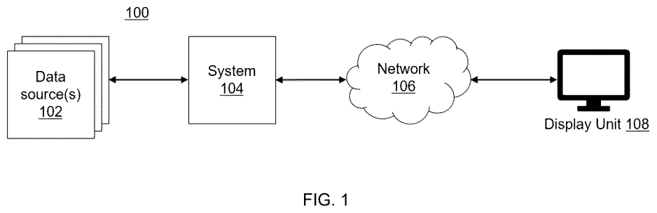

FIG. 1 is a diagram that illustrates an exemplary environment 100 within which various embodiments of the present disclosure may function. Referring to FIG. 1, the environment 100 comprises a plurality of data sources 102, a system 104, a network, 106, and a display unit 108.

The plurality of data sources 102 may refer to various domain-specific documents or repositories that contain relevant information, such as research papers, technical manuals, legal documents, industry reports, medical records, or any other sources of domain-specific knowledge. The plurality of data sources 102 can be structured, semi-structured, or unstructured and may exist in different formats, such as text files, PDFs, spreadsheets, or databases.

The system 104 refers to the automated ontology generation system, which processes the data from the data sources 102. The system 104 utilizes advanced techniques to extract entities, relationships, and attributes from the documents, and organizes this extracted data into an ontology. The system 104 may also incorporate data compliance mechanisms to identify and tag sensitive data, such as PII, PCI, and PHI, ensuring that the resulting ontology adheres to relevant data protection regulations.

The network 106 includes communication networks operable to facilitate communication, either wirelessly or wired. The network 106 connects a plurality of computer systems. The network 106 may comprise, for example, an intranet, local area network, wide area network, the internet, public switched telephone network (PSTN), network of networks, or other network.

In one or more embodiments, the network 106 facilitates connection between the system 104 and the display unit 108 via one or more communication channels.

In one or more embodiments, the display unit 108 is configured to present the generated ontologies for review to the user in an interactive manner. The display unit 108 can include, but is not limited to, devices such as, interactive dashboards, touchscreen displays, projection systems, and wearable displays.

In some non-limiting embodiments, the display unit 108 can be located within an enterprise environment or at any other remote location, providing flexibility in accessing and presenting insights to users. For instance, in an enterprise setting, the display unit 108 could be integrated into centralized workstations or conference room systems, facilitating collaborative decision-making among teams. Conversely, in remote locations, the display unit 108 could be accessed via portable devices such as laptops, tablets, or smartphones, ensuring seamless connectivity and uninterrupted workflow regardless of the user's physical location.

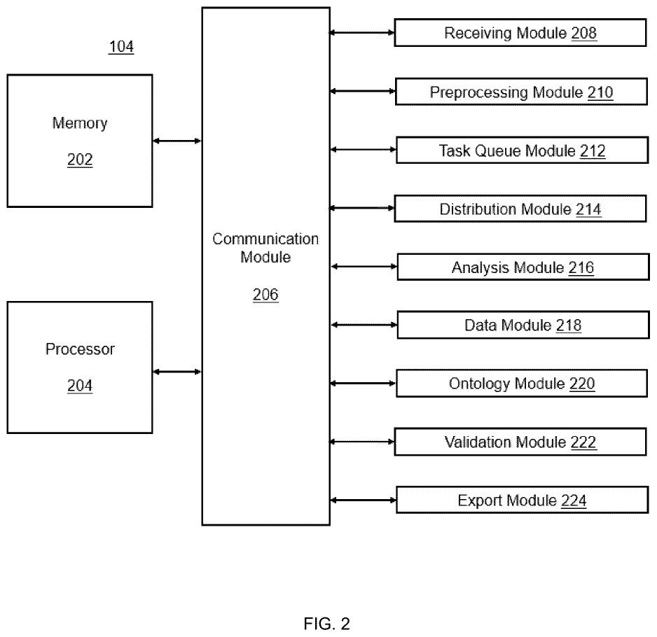

FIG. 2 is a diagram that illustrates the system 104 for automatically generating ontologies from domain-specific documents, in accordance with an embodiment of the disclosure. Referring to FIG. 2, comprises a memory 202, a processor 204, a communication module 206, a receiving module 208, a preprocessing module 210, a task queue module 212, a distribution module 214, an analysis module 216, a data module 218, an ontology module 220, a validation module 222, and an export module 224, wherein the modules are communicatively coupled via a system bus.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 104 in accordance with various aspects of the present disclosure. The processor 204 may be further configured to communicate with the various modules of the system 104 through the communication module 206, which manages internal and external data communications.

The receiving module 208 may comprise suitable logic, code, and/or interfaces that may be configured to receive a plurality of domain-specific documents from the plurality of data sources 102. The receiving module 208 implements document intake protocols that enable concurrent processing of multiple document streams, document format detection, metadata extraction, and preliminary validation. The receiving module 208 maintains a document processing queue and implements fault-tolerance mechanisms to ensure reliable document ingestion. The receiving module 208 generates structured document metadata records that include source information, format specifications, and processing requirements.

In one or more embodiments, the domain-specific documents received by the receiving module 208 may include a variety of file formats commonly used in professional and technical environments. For instance, the formats may include PDF (Portable Document Format), DOCX (Microsoft Word Document), and TXT (plain text files). The system 104 is equipped to handle different formats effectively, ensuring that text-based information, tables, figures, and other document structures are accurately parsed and converted into usable data for ontology creation.

In one or more embodiments, the data sources 102 from which the domain-specific documents are received may include a variety of storage locations and systems. The data sources 102 may comprise at least one of local storage systems, cloud repositories, and databases. Local storage refers to physical or networked storage devices within an organization's infrastructure, while cloud repositories are remote, web-based storage solutions that enable easy access and sharing of documents across various locations. Databases may include structured repositories that store large collections of documents or related data, often in relational or NoSQL formats.

The preprocessing module 210 may comprise suitable logic, code, and/or interface that may be configured to preprocess the plurality of domain-specific documents to generate normalized documents suitable for ontology extraction. The preprocessing module 210 implements document normalization pipelines that standardize document structure, content representation, and metadata format while preserving semantic integrity and relationship information.

In one or more embodiments, the preprocessing module 210 may be configured to implement a multi-stage text extraction pipeline to generate normalized documents. The pipeline processes domain-specific documents containing heterogeneous elements including, but not limited to, embedded images, structured tables, cross-referenced footnotes, and document metadata. The preprocessing module 210 employs content filtering algorithms that selectively extract textual information while systematically excluding non-contributory elements such as decorative images, formatting artifacts, and non-semantic structural elements. The extraction process maintains referential integrity between extracted text segments and preserves semantic relationships encoded in the document structure.

In one or more embodiments, the preprocessing module 210 may be configured to implement noise reduction algorithms to eliminate textual artifacts and irrelevant content from the extracted text. The noise reduction process addresses multiple categories of textual noise, including but not limited to structural artifacts (page numbers, headers, footers), typographical elements (unwanted characters, formatting markers), linguistic anomalies (misspellings, redundant phrases), and document-specific artifacts (auto-generated content, template residuals). The preprocessing module 210 employs specialized pattern recognition algorithms and statistical filters to identify and remove noise patterns while preserving the semantic integrity of the content. The noise reduction algorithms adapt to document-specific patterns and maintain a confidence score for each noise removal operation.

In one or more embodiments, the preprocessing module 210 may be configured to implement text standardization protocols to ensure uniform representation of extracted content. The standardization process includes multiple transformation stages including character encoding normalization (converting to UTF-8 or specified encoding standards), date and numerical format standardization (converting to ISO-8601 for dates and standardized numerical representations), language-specific normalization (handling multi-language content and ensuring consistent character sets), and structural standardization (implementing uniform paragraph delineation, list formatting, and section organization). The preprocessing module 210 maintains format conversion maps and applies rule-based transformations to ensure consistency across the normalized document corpus.

In one or more embodiments, the preprocessing module 210 may be configured to preprocess the plurality of domain-specific documents by implementing a predictive analysis model to identify potential gaps in document coverage, forecast missing entities based on historical domain patterns, suggest modifications to improve ontology completeness, and flag potential inconsistencies for expert review.

In one or more embodiments, the predictive analysis model is used to analyze the domain-specific documents and assess whether all key entities, concepts, and relationships relevant to the domain are sufficiently covered. By comparing the extracted text with expected domain patterns or predefined ontologies, the predictive analysis model can detect gaps where certain important entities or relationships are underrepresented or completely absent.

In one or more embodiments, the predictive analysis model uses historical domain patterns to forecast missing entities that are not explicitly mentioned in the documents but are typically found in other documents within the same domain. For example, if a scientific paper about a disease mentions symptoms but omits specific treatments, the predictive analysis model may predict which treatments are usually associated with that disease based on historical data from similar medical documents. The predictive analysis model learns from previously analyzed domain-specific documents to identify patterns and associations, allowing it to infer the presence of missing entities that should be incorporated into the ontology.

In one or more embodiments, as the predictive analysis model evaluates the documents, it identifies areas where the ontology can be expanded or refined to improve its completeness. This may involve suggesting the addition of new entities, relationships, or categories that are common in the domain but were not initially detected in the documents.

In one or more embodiments, the predictive analysis model is also capable of flagging potential inconsistencies within the documents that could impact the accuracy and reliability of the generated ontology. If there are conflicting pieces of information such as different definitions of the same entity or contradictory relationships between concepts the predictive analysis model can identify these discrepancies and flag them for expert review. For example, if one document refers to a particular process in one way and another document contradicts it, the predictive analysis model would highlight this inconsistency. Additionally, the predictive analysis model can detect logical inconsistencies in the ontology, such as entities that are misclassified or relationships that do not make sense in the context of the domain.

The preprocessing module 210 may be configured to perform a critical initial step in the ontology generation process by identifying named entities within the normalized documents. Named entities refer to specific terms or phrases that represent real-world objects, such as persons, organizations, locations, dates, and other domain-specific concepts. The preprocessing module 210 may be configured to apply advanced natural language processing techniques to automatically recognize and extract these entities from the documents, which may be in various formats such as text, PDF, or DOCX.

Once the named entities are identified, the preprocessing module 210 may be configured to classify them into predefined categories based on their semantic meaning and contextual relevance. These categories may include, but not limited to, general classifications like “Person,” “Location,” “Organization,” as well as domain-specific categories depending on the particular focus of the ontology, such as “Product,” “Service,” “Transaction,” or “Disease” for healthcare-related ontologies. The classification process ensures that entities are grouped in a way that reflects their roles and relationships within the broader domain.

Following classification, the preprocessing module 210 may be configured to establish hierarchical relationships between the classified entities. This step defines how the entities interact with one another within the domain. For example, a “Person” entity might have a hierarchical relationship with an “Organization” entity, such as “Employee” or “Manager,” or a “Location” entity could be related to an “Event” entity as the venue for a specific activity. By mapping these relationships, the preprocessing module 210 may be configured to help to structure the entities in a way that facilitates the creation of a comprehensive ontology, where entities are organized not only by their individual attributes but also by how they relate to other entities within the domain.

The preprocessing module 210 plays a crucial role in refining the domain-specific documents and ensuring the accuracy and comprehensiveness of the resulting ontology. The preprocessing module 210 may be configured to verify the coverage of domain-specific concepts within the documents, ensuring that all relevant entities, relationships, and properties associated with the domain are identified and represented.

The preprocessing module 210 may also be configured to check the consistency of relationships between entities. In a well-constructed ontology, entities should be connected by logical, meaningful relationships that reflect real-world connections. The preprocessing module 210 may be configured to evaluate the extracted relationships for any inconsistencies, such as conflicting or ambiguous connections between entities, and flags them for further review.

The preprocessing module 210 may also be configured to identify potential gaps in the hierarchical knowledge structure of the ontology. Hierarchical relationships are essential in building a taxonomy of concepts, with broader categories encompassing more specific ones. By identifying missing hierarchical links, the preprocessing module 210 may be configured to ensure that the ontology reflects a complete, logical organization of concepts, preventing the ontology from being fragmented or incomplete. The gaps might involve missing parent-child relationships or the absence of intermediate levels within the hierarchy that would improve the overall structure of the ontology.

In one or more embodiments, the preprocessing module 210 may be configured to verify the completeness of entity properties. Each entity in an ontology is typically associated with specific attributes or properties that describe its characteristics. The preprocessing module 210 may be configured to check that all relevant properties for each entity are captured and ensures that no critical information is left out.

The task queue module 212 may comprise suitable logic, code, and/or interfaces that are configured to maintain a task queue configured to enable parallel processing across multiple processing units. In one or more embodiments, the task queue module 212 organizes and manages tasks in a queue, ensuring that each task is assigned to an appropriate processing unit based on its workload, capabilities, and availability.

In some non-limiting embodiments, as tasks are completed, the task queue module 212 may be configured to dynamically update the queue to assign new tasks to available processing units. By enabling parallel processing, the task queue module 212 significantly reduces the time required to preprocess, analyze, and generate the necessary outputs, such as ontology data or document insights, from the domain-specific documents.

In one or more embodiments, the task queue module 212 implements a specialized batching algorithm that divides large datasets into processing units based on contextual relationships. The algorithm analyzes document content to identify semantic connections and groups related documents into contextually coherent batches. Each batch is assigned a priority score based on multiple factors including content complexity, semantic relationships, and processing dependencies.

The task queue module 212 employs a priority-based queuing mechanism that processes batches according to their assigned priority scores. This mechanism optimizes processing efficiency while maintaining contextual integrity across batches. The task queue module 212 tracks batch processing status and dynamically adjusts queue priorities based on system load and processing metrics.

In one or more embodiments, the task queue module 212 coordinates with multiple processing units that leverage Generative AI models to generate Subject-Predicate-Object (SPO) triples in parallel. Each processing unit operates independently on its assigned batch while maintaining semantic consistency. The task queue module 212 implements synchronization protocols to ensure that parallel processing operations do not compromise the semantic integrity of the generated ontologies.

The task queue module 212 implements a specialized consolidation algorithm that combines individual batch outputs into a unified final output. This algorithm performs semantic deduplication, ensures relationship consistency, and maintains entity property integrity across all processed batches. The consolidation process includes validation checks to verify that entity relationships remain intact across different processing batches.

In one or more embodiments, each processing unit in the parallel processing array operates independently to generate SPO formatted data using Generative AI models. As each processor completes its assigned batch, it submits its output to a central consolidation queue. The consolidation algorithm processes these submissions sequentially, performing real-time semantic validation and deduplication as new outputs are received. This approach ensures that data integrity is maintained throughout the parallel processing operation, even as multiple processors simultaneously contribute to the final consolidated output.

Upon completion of all batch processing operations, the task queue module 212 initiates a post-processing phase that performs comprehensive validation of the consolidated output. This phase ensures that parallel processing has not introduced semantic inconsistencies or relationship errors. The task queue module 212 employs verification algorithms to check entity relationships, property assignments, and semantic coherence across the entire processed dataset.

The distribution module 214 may comprise suitable logic, code, and/or interfaces that may be configured to distribute the normalized documents to the task queue. Once the preprocessing module 210 has generated the normalized documents by extracting, cleaning, and standardizing the text from the domain-specific documents, the distribution module 214 ensures that these normalized documents are efficiently allocated to the task queue for parallel processing across multiple processing units.

In an exemplary embodiment, the distribution module 214 may also incorporate a mechanism for dynamically adjusting task distribution based on real-time processing feedback. For example, if certain processing units are lagging or experiencing delays, the distribution module 214 may be configured to reassign tasks from those units to others that are performing more efficiently.

The analysis module 216 may comprise suitable logic, code, and/or interfaces that may be configured to analyze content within the normalized documents using natural language processing techniques and generative AI techniques to extract domain-specific entities, entity relationships between the domain-specific entities, and entity properties associated with the domain-specific entities.

In one or more embodiments, the analysis module 216 may be configured to process the content of the normalized documents using the natural language processing techniques and the generative AI techniques, incorporating a large language model (LLM) to perform various critical tasks. The tasks include, but not limited to, context-aware processing, disambiguation of terms, generation of semantic relationships between entities, and validation of the extracted relationships.

The analysis module 216 may be configured to implement the LLM to perform context-aware processing of the normalized documents. In this step, the LLM analyzes the entire document within its broader context, considering not only individual words but also how they relate to one another throughout the document. This context-aware processing enables the LLM to understand the meaning of terms based on the surrounding context, which is especially important in complex or specialized domains where words may have multiple meanings.

In one or more embodiments, the analysis module 216 may be configured to utilize the LLM to disambiguate terms within the domain-specific documents. Many terms in domain-specific texts can be ambiguous or have different meanings depending on the context. The LLM uses its trained knowledge to resolve such ambiguities by considering the surrounding text, syntactic structure, and semantic clues to identify the correct meaning of each term. The disambiguation process ensures that the correct entities are identified and classified appropriately, which is vital for ensuring that the ontology reflects the true domain knowledge.

The analysis module 216 may be configured to generate semantic relationships between the extracted domain-specific entities using the LLM. Once the entities have been identified and disambiguated, the LLM generates semantic relationships that describe how the entities are connected. These relationships could include actions, associations, hierarchies, or other forms of relationships specific to the domain. For example, in a scientific paper, the LLM might identify relationships such as “Gene X is associated with Disease Y” or “Researcher A conducted Study B.” By generating these relationships, the LLM helps to build a structured representation of the domain knowledge, forming the foundation for constructing an ontology that accurately reflects how entities interact within the domain.

In one or more embodiments, the analysis module 216 may be configured to validate the extracted relationships using contextual analysis. After generating the relationships, the LLM applies contextual analysis to ensure that the relationships are valid and make sense within the context of the domain. This validation process checks for inconsistencies, contradictions, or errors in the generated relationships. For instance, if the LLM extracts a relationship that suggests two entities are connected in a way that is not supported by the context or the domain's rules, the system 104 can flag it for review or refinement.

In one or more embodiments, the analysis module 216 utilizes multiple processing units that are operating in parallel, to analyze the content. By distributing the analysis workload across multiple processing units, the system 104 can perform various NLP tasks simultaneously, significantly reducing the time required to process and analyze the documents.

The data module 218 may comprise suitable logic, code, and/or interfaces that may be configured to generate subject-predicate-object (SPO) formatted data based on the extracted domain-specific entities, the extracted entity relationships, and the extracted entity properties.

In one or more embodiments, the SPO format represents the extracted knowledge in a structured triplet form, where the subject represents an entity, the predicate signifies the relationship or association, and the object denotes another entity or property linked to the subject. For instance, in a medical domain, an example SPO triplet might be “Aspirin” (subject)—“is used to treat” (predicate)—“Headache” (object). This structured representation simplifies the understanding of relationships and ensures consistency in how domain knowledge is organized.

In one or more embodiments, the data module 218 utilizes the outputs from the analysis module 216 to create SPO triplets by correlating the extracted entities, relationships, and properties. For example, after identifying entities such as “Researcher,” “Study,” and “Institution,” along with their respective relationships like “conducts” or “is part of,” the data module 218 formats this information into a comprehensive set of SPO triplets.

The data module 218 may be configured to generate the SPO formatted data through an advanced and collaborative approach that leverages multiple artificial intelligence models operating in parallel such as, NLP model, LLM, and prediction model.

In one or more embodiments, the NLP model is responsible for the foundational task of extracting entities from the normalized documents. It identifies key terms, concepts, and domain-specific elements, ensuring comprehensive coverage of the text.

In one or more embodiments, building upon the basic extraction, the LLM adds a layer of contextual understanding. It interprets the relationships and properties between entities based on their usage and context within the document. For example, it can discern that “Investor” is linked to “Transaction” through a predicate such as “participates in” based on the surrounding text.

In one or more embodiments, the prediction model focuses on ensuring the semantic and contextual accuracy of the relationships identified. By analyzing historical patterns, domain-specific rules, and statistical correlations, the prediction model validates the extracted relationships and flags anomalies or uncertainties for further review.

In one or more embodiments, the data module 218 may be configured to generate the SPO formatted data by aggregating the outputs from the AI models to create a unified representation of the entities, relationships, and properties. Each model contributes specialized insights, with the NLP model providing the raw entity data, the LLM enriching it with contextual relationships, and the prediction model offering validated connections.

In one or more embodiments, in cases where the outputs of the models differ or conflict for instance, when one model identifies a relationship while another does not, the data module 218 employs a weighted scoring system to resolve discrepancies. Each model is assigned a weight based on factors such as accuracy, reliability, and domain relevance. The data module 218 evaluates the conflicting outputs and determines the most likely result, prioritizing consensus or high-confidence predictions. For example, if the LLM and prediction model agree on a relationship, but the NLP model does not, the consensus of the former two would carry more weight in the final decision.

The ontology module 220 may comprise suitable logic, code, and/or interfaces that may be configured to construct an ontology by combining the generated SPO formatted data to create a hierarchical knowledge structure.

In one or more embodiments, the ontology module 220 processes the SPO formatted data by organizing the extracted domain-specific entities, their relationships, and associated properties into a hierarchical framework. The hierarchical framework categorizes entities into classes and subclasses, defines their interconnections, and specifies their attributes.

In one or more embodiments, the ontology module 220 is configured to identify sensitive data within the ontology using a detection algorithm, and tag the identified sensitive data within the hierarchical knowledge structure. The sensitive data may include, but not limited to, a personally identifiable information (PII), a payment card industry (PCI) data, a protected health information (PHI).

In one or more embodiments, the ontology module 220 may be configured to identify sensitive data within the ontology by employing the detection algorithm that leverages techniques such as pattern matching, NLP, and machine learning models. The detection algorithm is capable of scanning entity names, relationships, and properties for characteristics indicative of sensitive information. For instance, it can recognize patterns such as Social Security numbers (SSNs), credit card numbers, medical record identifiers, or other domain-specific sensitive data attributes.

In one or more embodiments, the detection algorithm implements a multi-layered approach to sensitive data identification. The detection algorithm first performs metadata analysis of the ontological elements, examining entity names, property descriptors, and relationship identifiers to detect potential sensitive data fields based on nomenclature patterns and semantic indicators.

The detection algorithm employs pattern matching techniques utilizing specialized regular expressions. These expressions are configured to identify structured sensitive data formats including, but not limited to, IP addresses, email addresses, social security numbers, and other standardized identifying information. The pattern matching engine maintains a repository of regular expressions that is extensible to accommodate new patterns as they emerge.

The detection algorithm incorporates a reference data matching system that utilizes comprehensive datasets for sensitive information identification. These datasets include, but are not limited to, geographical information (country names, country codes), demographic data (country-specific personal names, cultural identifiers), and other domain-specific reference data. The matching system implements efficient lookup mechanisms and fuzzy matching algorithms to identify variations and partial matches.

In one or more embodiments, the detection algorithm integrates specialized validation algorithms for specific types of sensitive data. For example, the algorithm implements the Luhn algorithm (modulus 10) for credit card number validation, checksum algorithms for identification numbers, and other standardized validation protocols. These validation algorithms ensure that identified sensitive data not only matches expected patterns but also satisfies mathematical and logical validation criteria.

The detection algorithm processes both structured and unstructured components of the ontology, analyzing entity properties, relationships, and associated metadata in parallel to ensure comprehensive sensitive data identification. The detection algorithm maintains detection accuracy metrics and confidence scores for each identified instance of sensitive data, enabling fine-grained control over sensitivity classification and subsequent data handling procedures.

Once the sensitive data is identified, the ontology module 220 may be configured to tag this information within the hierarchical knowledge structure. The tagging process involves assigning metadata to the entities, properties, or relationships that contain or reference sensitive data. The metadata may include classifications such as PII, PCI data, or PHI, depending on the nature of the identified data.

For example:
If the ontology contains an entity such as “Patient Name” linked to a medical record, it is tagged as PHI.
Credit card details within a payment system ontology are tagged as PCI data.
Attributes such as email addresses or phone numbers are classified and tagged as PII.

In some one or more embodiments, the tagging process may be further augmented by integrating compliance rule sets specific to regulations such as the General Data Protection Regulation (GDPR), the Health Insurance Portability and Accountability Act (HIPAA), or the Payment Card Industry Data Security Standard (PCI DSS).

In one or more embodiments, the ontology module 220 may be configured to employ pattern recognition techniques to identify and classify sensitive data within the hierarchical knowledge structure. The techniques are designed to detect predefined patterns associated with sensitive data elements, such as numerical sequences resembling credit card numbers, email address formats, or identifiers commonly found in healthcare records. Beyond simple pattern detection, the ontology module 220 analyzes the context surrounding potential sensitive data elements to enhance the accuracy of detection.

Once sensitive data elements are identified, the ontology module 220 may be configured to classify them into appropriate sensitivity categories based on predefined rules and domain-specific regulatory requirements. The classification ensures that the detected data is appropriately tagged and handled within the ontology, enabling downstream processes to enforce compliance measures, enhance security protocols, and maintain data integrity. By combining pattern recognition with contextual analysis, the ontology module 220 achieves a high degree of accuracy and reliability in detecting and categorizing sensitive information, thereby addressing critical challenges in data compliance and privacy management.

In one or more embodiments, the ontology module 220 may be configured to implement stringent access controls for tagged sensitive data within the hierarchical knowledge structure. The access controls ensure that only authorized users can view or interact with sensitive information, thereby safeguarding it against unauthorized access or misuse. The ontology module 220 achieves this by leveraging role-based access control (RBAC) mechanisms, wherein access rights are assigned based on the roles and responsibilities of individual users or groups. For instance, a system administrator might have full access to the ontology, while a general user may only have permissions to view non-sensitive portions of the data.

In some non-limiting embodiments, in addition to RBAC, the ontology module 220 can enforce dynamic access policies that consider contextual factors such as the time of access, the location of the user, or the type of device being used. By implementing the access control measures, the ontology module 220 not only protects the integrity and confidentiality of sensitive data but also ensures compliance with regulatory frameworks such as GDPR, HIPAA, and PCI DSS, which mandate strict control over the handling of personal and sensitive information.

The ontology module 220 may be configured to maintain a comprehensive audit trail of all interactions with tagged sensitive data within the ontology. The audit trail records detailed information about every access attempt, modification, or query made to sensitive data, ensuring full traceability of who accessed the data, when they accessed it, and the nature of the interaction. Each entry in the audit trail typically includes the identity of the user or system involved, the type of operation performed (e.g., read, write, modify, or delete), and a timestamp indicating when the action occurred.

In one or more embodiments, the ontology module 220 may also be configured to enable selective masking or encryption of tagged sensitive data during the export process, ensuring that sensitive information remains protected when shared or transferred outside the secure environment. The functionality is essential for maintaining data privacy and security, particularly when the ontology is being exported to external systems, partners, or applications for further processing or analysis.

In an exemplary embodiment, selective masking refers to the process of replacing sensitive data elements with placeholder values or redacting them entirely during the export. For example, PII, such as names or addresses, may be substituted with generic symbols or masked values (e.g., “XXXX” or “****”) to prevent exposure.

The ontology module 220 may be configured to apply a machine learning model that is trained on labeled sensitive data examples to enhance its ability to detect and classify sensitive information within the ontology. The machine learning model learns to recognize patterns and characteristics of sensitive data by analyzing a large set of labeled examples, where sensitive data elements, such as PII, PCI data, and PHI, are explicitly marked.

The ontology module 220 may be configured to utilize regular expression (regex) patterns to efficiently identify standardized sensitive data formats within the ontology. Regular expressions are powerful tools for detecting and extracting specific patterns of text, which is particularly useful for recognizing structured or well-defined sensitive data types. For example, sensitive data formats such as email addresses, phone numbers, credit card numbers, and social security numbers often follow consistent patterns that can be captured through regular expressions.

The ontology module 220 may be configured to implement contextual analysis rules designed to identify domain-specific sensitive information by considering the surrounding context in which the data appears within the ontology. Unlike simple pattern-matching techniques, contextual analysis goes beyond just recognizing the structure of the data; it focuses on understanding the relationships and significance of data elements within the broader context of the document or dataset.

In an exemplary embodiment, the contextual analysis rules are created to capture the nuances of the domain-specific language, ensuring that sensitive information is detected not just based on its format (e.g., a credit card number or email address) but also based on its contextual relevance within the document.

The validation module 222 may comprise suitable logic, code, and/or interfaces that may be configured to validate the ontology by verifying completeness of entity relationships and entity properties within the hierarchical knowledge structure.

In one or more embodiments, the validation module 222 may be configured to perform a thorough examination of the constructed ontology to verify that all extracted domain-specific entities, their relationships, and associated properties are accurately represented. The validation module 222 ensures that every SPO triplet generated during the data processing stages has been appropriately integrated into the hierarchical structure.

In one or more embodiments, the validation module 222 may be configured to validate the ontology by implementing an AI-driven validation pipeline comprising semantic consistency checking using LLMs, structural validation using graph neural networks, completeness assessment using predictive models, and anomaly detection using supervised learning models.

In one or more embodiments, the validation pipeline includes semantic consistency checking powered by LLMs. The LLMs are employed to interpret and analyze the ontology's content, verifying that the relationships between entities align with domain-specific semantics. For instance, if the ontology includes entities such as “Doctor” and “Patient” linked by the relationship “treats,” the LLM checks whether this relationship is semantically appropriate in the given context. Any conflicting or illogical relationships, such as linking “Patient” to “Hospital” with the predicate “owns,” are flagged for review.

The validation pipeline also includes structural validation, utilizing graph neural networks (GNNs) to evaluate the hierarchical organization of the ontology. GNNs assess the topology of the ontology graph, ensuring that entities and their relationships form a coherent structure.

To assess the completeness of the ontology, the validation module 222 uses predictive models trained on historical domain-specific patterns. The predictive models analyze the ontology to identify missing entities, properties, or relationships that are expected based on known domain knowledge.

The validation pipeline also incorporates anomaly detection using supervised learning models. The supervised models are trained on annotated data to recognize deviations from normal patterns within the ontology. For instance, if a relationship in the ontology has an unusually high number of associated properties or an entity is linked to an unrelated domain, the anomaly detection system flags these irregularities.

The export module 224 may comprise suitable logic, code, and/or interfaces that may be configured to export the ontology in a knowledge representation format comprising one of Web Ontology Language (OWL) or Resource Description Framework (RDF). OWL is a widely used standard for representing ontologies in a machine-readable format that supports reasoning about the relationships between entities. It enables the ontology to incorporate complex relationships, class hierarchies, and constraints, making it ideal for applications that require logical inference and semantic analysis. For instance, an ontology exported in OWL can be used by reasoning engines to infer new facts or validate existing relationships.

In one or more embodiments, the RDF is another common format used for representing structured data as triples (SPO). By exporting the ontology in RDF, the export module 224 ensures compatibility with a broad range of data integration, semantic search, and linked data applications. RDF provides a lightweight and flexible framework for storing and exchanging knowledge, making it suitable for web-based knowledge graphs and semantic web technologies.

In one or more embodiments, the system 104 may be configured to provide an intuitive interface on the display unit 108 that allows domain experts and SMEs to review the ontology and contribute refinements as necessary. The expert review interface is designed to facilitate the validation of the ontology, ensuring that the knowledge structure accurately reflects the domain's terminology, relationships, and data properties. Experts can examine the generated ontology, identify any gaps, inconsistencies, or inaccuracies, and provide feedback directly through the interface.

Once the experts review the ontology, they can submit refinements through the interface, which may include corrections to identified entities, adjustments to relationships, or the addition of new entities and properties that were missed during the automated ontology generation process. Additionally, the interface may allow experts to provide suggestions for improving the contextual understanding of the ontology, such as adjusting the classification of certain terms or revising the relationships between entities to better capture the domain's intricacies.

In one or more embodiments, the system 104 may be configured to efficiently incorporate these refinements into the ontology. After receiving the updates from the expert review, the system 104 automatically integrates the refinements into the existing ontology, ensuring that the updated version is comprehensive, accurate, and aligned with domain-specific requirements.

In one or more embodiments, the system 104 is configured to generate an application programming interface (API) that allows users and applications to interact with the ontology in a standardized and programmatically accessible manner. The API provides a set of endpoints that enable external systems, services, or users to query, retrieve, and manipulate the ontology data. It acts as a bridge between the ontology and various applications that require structured domain knowledge for different use cases such as knowledge graph creation, data integration, and analytics.

Consider an exemplary embodiment demonstrating generation of an ontology and exporting the same to the display unit 108. In accordance with the exemplary embodiment, a company, XYZ Healthcare, aims to create an ontology for medical records and patient data in order to improve their data analytics for healthcare decision-making. XYZ Healthcare possesses a variety of domain-specific documents such as patient discharge summaries, medical research papers, and medical guidelines, all stored in different formats like PDFs, DOCX, and TXT files. The process of automatically generating an ontology from domain-specific documents begins with the receiving module 208.

The receiving module 208 of the system 104 receives a large collection of domain-specific documents from multiple data sources within the company's data infrastructure, which include both local storage and cloud repositories. The documents range from patient records to medical articles, all rich with healthcare-specific terms and concepts. The receiving module 208 ensures that these documents, regardless of format, are received in a structured manner, enabling seamless further processing.

The preprocessing module 210 normalizes the documents. The preprocessing module 210 extracts text from the received documents, removing non-informative elements like headers, footers, and images. The extracted text undergoes cleaning to remove irrelevant noise (e.g., advertisements or irrelevant metadata) and is standardized into a uniform format. This process ensures that all documents are in a consistent format and free of noise, making them suitable for downstream analysis. Named entities such as “patient,” “diagnosis,” and “medication” are identified and categorized into predefined entities such as “Person,” “Medical Condition,” and “Medication.”

The normalized documents are then forwarded to the analysis module 216, which utilizes NLP techniques powered by a LLM to analyze the extracted text. The LLM performs context-aware processing, disambiguates terms, and identifies domain-specific entities like “Hypertension,” “Aspirin,” and “Blood Pressure.” Furthermore, it generates semantic relationships between these entities, such as “Aspirin treats Hypertension,” and validates these relationships using contextual analysis. For instance, the relationship between “Hypertension” and “Blood Pressure” is confirmed as valid through contextual validation, ensuring that entities are correctly linked according to medical knowledge.

To handle the vast amount of data and expedite processing, the task queue module 212 distributes the task of analyzing different documents across multiple processing units working in parallel.

Once the entities and relationships are extracted, the data module 218 begins the task of converting the raw information into a structured format. Using multiple AI models, including NLP for entity extraction, a LLM for contextual understanding, and a prediction model for relationship validation, the data module 218 generates SPO triples. For example, from the analysis of a document, the following SPO triple might be generated:
(“Aspirin,” “treats,” “Hypertension”)

The structured SPO data is then passed to the ontology module 220, which constructs an ontology by combining the extracted entities and relationships. It creates a hierarchical knowledge structure that classifies and organizes entities like “Disease,” “Treatment,” and “Medication,” placing “Hypertension” under the “Disease” category and linking “Aspirin” under the “Medication” category. The ontology now serves as a robust representation of the healthcare domain, capturing the essential knowledge needed for decision-making and analysis.

The validation module 222 performs a comprehensive validation of the generated ontology. It checks for completeness, ensuring that all important entities and relationships are captured.

The system 104 then provides an interface for expert review, allowing medical professionals and data scientists to inspect the generated ontology. Experts can suggest refinements, such as adding new relationships (e.g., linking “Aspirin” to “Side Effects”) or correcting any inaccuracies. These refinements are fed back into the system 104, where the ontology is updated based on expert feedback.

Once the ontology is validated and refined, the export module 224 exports the finalized ontology in industry-standard knowledge representation formats like OWL or RDF. XYZ Healthcare can now use this ontology to power various applications, such as automated medical records classification, advanced analytics, and even machine learning models for predictive healthcare insights.

The generated ontology will typically include:
Entities (Classes): These are the high-level concepts within the domain. For example, in the healthcare domain, entities might include:
   Person
   Disease
   Medication
   Treatment
   Symptom
   Side Effect
Entity Relationships (Object Properties): These define the relationships between entities. For example:
   “Aspirin” treats “Hypertension”
   “Hypertension” has symptom “High Blood Pressure”
   “Patient” receives “Treatment”
Entity Properties (Data Properties): These describe the characteristics or attributes of the entities. For example:
   “Aspirin” has dose “500 mg”
   “Patient” has age “50”
Hierarchy (Class Subclass Structure): This defines how entities are related in terms of generalization or specialization. For example:
   Disease→Cardiovascular Disease
   Medication→Painkiller→Aspirin

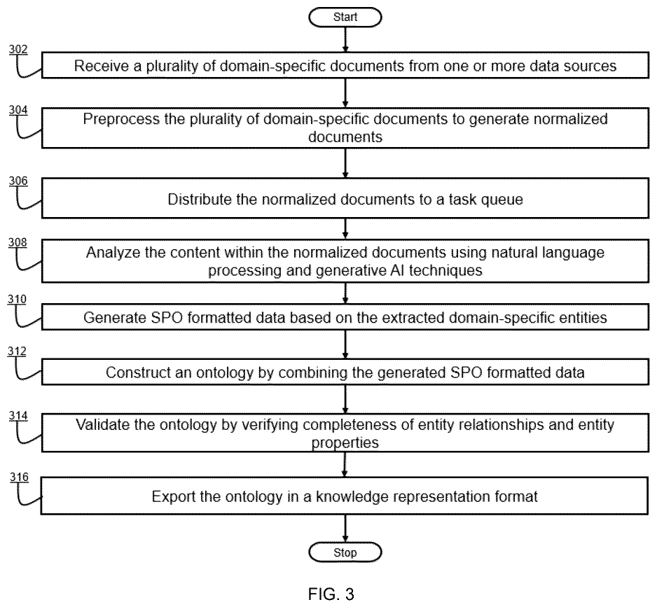

FIG. 3 is a diagram that illustrates a flow chart 300 for a method for automatically generating ontologies from domain-specific documents, in accordance with an embodiment of the disclosure.

At 302, a plurality of domain-specific documents from the plurality of data sources 102 are received by the receiving module 208. In one or more embodiments, the domain-specific documents received by the receiving module 208 may include a variety of file formats commonly used in professional and technical environments. For instance, the formats may include PDF (Portable Document Format), DOCX (Microsoft Word Document), and TXT (plain text files). The system 104 is equipped to handle different formats effectively, ensuring that text-based information, tables, figures, and other document structures are accurately parsed and converted into usable data for ontology creation.

In one or more embodiments, the data sources 102 from which the domain-specific documents are received may include a variety of storage locations and systems. The data sources 102 may comprise at least one of local storage systems, cloud repositories, and databases. Local storage refers to physical or networked storage devices within an organization's infrastructure, while cloud repositories are remote, web-based storage solutions that enable easy access and sharing of documents across various locations. Databases may include structured repositories that store large collections of documents or related data, often in relational or NoSQL formats.

At 304, the plurality of domain-specific documents are preprocessed by the preprocessing module 210 to generate normalized documents. In one or more embodiments, the normalized documents are generated by extracting text from the plurality of domain-specific documents. Domain-specific documents can contain a variety of elements, including images, tables, footnotes, or metadata, which may not be directly relevant for the generation of an ontology. The preprocessing module 210 extracts only the textual content from the documents, removing any non-essential elements, such as images, charts, or formatting that do not contribute to the ontological analysis.

In one or more embodiments, the normalized documents are generated by removing textual noise from the extracted text. Textual noise refers to any irrelevant or extraneous content within the document that may hinder the proper analysis of the data, which includes unwanted characters, misspellings, redundant phrases, or even artifacts left by the document formatting (such as page numbers, headers, and footers). The preprocessing module 210 uses specialized algorithms to identify and eliminate this noise, ensuring that the extracted text is as clean and accurate as possible.

In one or more embodiments, the normalized documents are generated by standardizing a format of the extracted text. The preprocessing module 210 may apply formatting rules to convert the extracted text into a uniform structure, which could include standardizing the text's character encoding, converting different date or number formats into a common style, and ensuring consistent punctuation or grammar usage.

In one or more embodiments, the preprocessing module 210 preprocesses the plurality of domain-specific documents by implementing a predictive analysis model to identify potential gaps in document coverage, forecast missing entities based on historical domain patterns, suggest modifications to improve ontology completeness, and flag potential inconsistencies for expert review.

At 306, the normalized documents are distributed to a task queue configured to enable parallel processing across multiple processing units. In one or more embodiments, the task queue module 212 organizes and manages tasks in a queue, ensuring that each task is assigned to an appropriate processing unit based on its workload, capabilities, and availability.

Once the preprocessing module 210 has generated the normalized documents by extracting, cleaning, and standardizing the text from the domain-specific documents, the distribution module 214 ensures that these normalized documents are efficiently allocated to the task queue for parallel processing across multiple processing units.

At 308, content within the normalized documents is analyzed by the analysis module 216 using natural language processing techniques and generative AI techniques.

In one or more embodiments, the analysis module 216 is designed to process the content of the normalized documents using natural language processing techniques and generative AI techniques, incorporating a large language model (LLM) to perform various critical tasks. The tasks include context-aware processing, disambiguation of terms, generation of semantic relationships between entities, and validation of the extracted relationships.

The analysis module 216 implements the LLM to perform context-aware processing of the normalized documents. In this step, the LLM analyzes the entire document within its broader context, considering not only individual words but also how they relate to one another throughout the document. This context-aware processing enables the LLM to understand the meaning of terms based on the surrounding context, which is especially important in complex or specialized domains where words may have multiple meanings.

In one or more embodiments, the analysis module 216 utilizes the LLM to disambiguate terms within the domain-specific documents. Many terms in domain-specific texts can be ambiguous or have different meanings depending on the context. The LLM uses its trained knowledge to resolve such ambiguities by considering the surrounding text, syntactic structure, and semantic clues to identify the correct meaning of each term. The disambiguation process ensures that the correct entities are identified and classified appropriately, which is vital for ensuring that the ontology reflects the true domain knowledge.

At 310, SPO formatted data is generated by the data module 218 based on the extracted domain-specific entities, the extracted entity relationships, and the extracted entity properties.

In one or more embodiments, the SPO format represents the extracted knowledge in a structured triplet form, where the subject represents an entity, the predicate signifies the relationship or association, and the object denotes another entity or property linked to the subject. For instance, in a medical domain, an example SPO triplet might be “Aspirin” (subject)—“is used to treat” (predicate)—“Headache” (object). This structured representation simplifies the understanding of relationships and ensures consistency in how domain knowledge is organized.

In one or more embodiments, the data module 218 leverages the outputs from the analysis module 216 to create SPO triplets by correlating the extracted entities, relationships, and properties. For example, after identifying entities such as “Researcher,” “Study,” and “Institution,” along with their respective relationships like “conducts” or “is part of,” the data module 218 formats this information into a comprehensive set of SPO triplets.

The data module 218 generates the SPO formatted data through an advanced and collaborative approach that leverages multiple artificial intelligence models operating in parallel such as, NLP model, LLM, and prediction model.

At 312, an ontology is constructed by the ontology module 220 by combining the generated SPO formatted data to create a hierarchical knowledge structure.

In one or more embodiments, the ontology module 220 processes the SPO formatted data by organizing the extracted domain-specific entities, their relationships, and associated properties into a hierarchical framework. The hierarchical framework categorizes entities into classes and subclasses, defines their interconnections, and specifies their attributes.

In one or more embodiments, the ontology module 220 is configured to identify sensitive data within the ontology using a detection algorithm, and tag the identified sensitive data within the hierarchical knowledge structure. The sensitive data comprises at least one of a personally identifiable information (PII), a payment card industry (PCI) data, a protected health information (PHI).

In one or more embodiments, the ontology module 220 identifies sensitive data within the ontology by employing a detection algorithm that leverages techniques such as pattern matching, NLP, and machine learning models. The detection algorithm is capable of scanning entity names, relationships, and properties for characteristics indicative of sensitive information. For instance, it can recognize patterns such as Social Security numbers (SSNs), credit card numbers, medical record identifiers, or other domain-specific sensitive data attributes.

At 314, the ontology is validated by verifying completeness of entity relationships and entity properties within the hierarchical knowledge structure.

In one or more embodiments, the validation module 222 performs a thorough examination of the constructed ontology to verify that all extracted domain-specific entities, their relationships, and associated properties are accurately represented. The validation module 222 ensures that every SPO triplet generated during the data processing stages has been appropriately integrated into the hierarchical structure.

In one or more embodiments, the validation module 222 validates the ontology by implementing an AI-driven validation pipeline comprising semantic consistency checking using LLMs, structural validation using graph neural networks, completeness assessment using predictive models, and anomaly detection using supervised learning models.

In one or more embodiments, the validation pipeline includes semantic consistency checking powered by LLMs. The LLMs are employed to interpret and analyze the ontology's content, verifying that the relationships between entities align with domain-specific semantics. For instance, if the ontology includes entities such as “Doctor” and “Patient” linked by the relationship “treats,” the LLM checks whether this relationship is semantically appropriate in the given context. Any conflicting or illogical relationships, such as linking “Patient” to “Hospital” with the predicate “owns,” are flagged for review.

At 316, the ontology is exported in a knowledge representation format comprising one of OWL or RDF. OWL is a widely used standard for representing ontologies in a machine-readable format that supports reasoning about the relationships between entities. It enables the ontology to incorporate complex relationships, class hierarchies, and constraints, making it ideal for applications that require logical inference and semantic analysis. For instance, an ontology exported in OWL can be used by reasoning engines to infer new facts or validate existing relationships.

In one or more embodiments, the RDF is another common format used for representing structured data as triples (SPO). By exporting the ontology in RDF, the export module 224 ensures compatibility with a broad range of data integration, semantic search, and linked data applications. RDF provides a lightweight and flexible framework for storing and exchanging knowledge, making it suitable for web-based knowledge graphs and semantic web technologies.

The method and system is advantageous in that it overcomes the existing solutions by introducing a queue-based multiprocessing solution that processes domain-specific documents to automatically discover ontologies in SPO format, providing several distinct advantages. By leveraging queue-based multiprocessing, the system ensures efficient handling of large-scale document datasets, facilitating parallel processing to significantly reduce processing time. This architecture also enhances scalability, enabling the system to adapt to varying workloads and maintain high performance under increased demand.

Furthermore, the automatic discovery of ontologies in SPO format streamlines the process of knowledge extraction, eliminating the need for extensive manual intervention. This automation accelerates the generation of structured, machine-readable knowledge representations, ensuring consistency and accuracy in representing domain-specific entities, relationships, and properties. The integration of advanced natural language processing and machine learning techniques enhances the quality of the discovered ontologies by enabling contextual understanding and ensuring semantic precision.

The method and system is also advantageous in that it reduces the reliance on manual intervention, thereby accelerating the ontology discovery process and alleviating the burden on domain experts. By minimizing human involvement, the method reduces the likelihood of errors introduced by subjective biases or inconsistencies, ensuring a higher degree of accuracy and reliability in the generated ontology. Furthermore, the system's robust design ensures comprehensive data coverage by analyzing a wide range of domain-specific documents and identifying intricate relationships, entities, and properties with precision.

Additionally, the system incorporates custom logic to identify and tag sensitive entities, such as PII, PCI data, and PHI, within the ontology. This functionality is critical for enhancing data security and ensuring compliance with regulatory frameworks such as GDPR, HIPAA, and PCI DSS. By leveraging advanced detection algorithms, regular expression patterns, and machine learning models, the system accurately classifies sensitive data and tags it appropriately within the hierarchical knowledge structure.

The tagged sensitive entities are further safeguarded through measures such as access controls, audit trails, and the option for selective masking or encryption during data export. These features not only mitigate risks associated with unauthorized access or data breaches but also streamline compliance efforts by embedding security directly into the ontology creation process. As a result, the system delivers a secure and regulation-compliant ontology that is well-suited for deployment in industries handling sensitive information, including healthcare, finance, and e-commerce.

Additionally, the system is designed to handle an unlimited number of documents and file sizes, effectively addressing the scalability limitations inherent in existing solutions. By utilizing a queue-based multiprocessing architecture and leveraging distributed processing capabilities, the system ensures that large volumes of data are processed efficiently without compromising performance. This scalability enables seamless handling of diverse and complex document sets, regardless of their size or format, making it ideal for applications requiring extensive data processing.

Significantly, the system facilitates better decision-making and insights by ensuring comprehensive and accurate representation of domain knowledge through its automated ontology discovery process. By extracting domain-specific entities, relationships, and properties with high precision and validating them through advanced techniques such as contextual analysis and semantic consistency checks, the system creates a robust and reliable hierarchical knowledge structure. This validated ontology serves as a ground truth, eliminating ambiguities and enhancing the accuracy of downstream applications such as knowledge graphs, semantic search engines, and decision support systems.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for automatically generating ontologies from domain-specific documents, the method comprising:
receiving, by a processor, a plurality of domain-specific documents from one or more data sources;
preprocessing, by the processor, the plurality of domain-specific documents to generate normalized documents by performing one or more of:
extracting text from the plurality of domain-specific documents;
removing textual noise from the extracted text;
standardizing a format of the extracted text;
distributing, by the processor, the normalized documents to a task queue configured to enable parallel processing across multiple processing units;
analyzing, by the multiple processing units operating in parallel, content within the normalized documents using natural language processing techniques and generative AI to extract domain-specific entities, entity relationships between the domain-specific entities, and entity properties associated with the domain-specific entities;
generating, by the processor, subject-predicate-object (SPO) formatted data based on the extracted domain-specific entities, the extracted entity relationships, and the extracted entity properties;
constructing, by the processor, an ontology by combining the generated SPO formatted data to create a hierarchical knowledge structure;
validating, by the processor, the ontology by verifying completeness of entity relationships and entity properties within the hierarchical knowledge structure; and
exporting, by the processor, the ontology in a knowledge representation format comprising one of Web Ontology Language (OWL) or Resource Description Framework (RDF).

2. The method of claim 1, wherein preprocessing the plurality of domain-specific documents further comprises implementing a predictive analysis model to:
identify potential gaps in document coverage;
forecast missing entities based on historical domain patterns;
suggest modifications to improve ontology completeness; and
flag potential inconsistencies for expert review.

3. The method of claim 1, wherein analyzing the content using the natural language processing techniques and the generative AI comprises:
implementing a large language model to perform context-aware processing of the normalized documents;
utilizing the large language model to disambiguate terms within the domain-specific documents;
generating semantic relationships between the extracted domain-specific entities using the large language model; and
validating the extracted relationships using contextual analysis.

4. The method of claim 1, wherein analyzing the content to extract domain-specific entities comprises:
identifying named entities within the normalized documents;
classifying the identified entities into predefined categories; and
establishing hierarchical relationships between the classified entities.

5. The method of claim 1, wherein generating the SPO formatted data comprises:
implementing multiple artificial intelligence models operating in parallel, including: a natural language processing model for basic entity extraction, a large language model for contextual understanding, and a prediction model for relationship validation;
aggregating outputs from the multiple artificial intelligence models; and
resolving conflicts between model outputs using a weighted scoring system.

6. The method of claim 1, wherein validating the ontology comprises:
implementing an AI-driven validation pipeline comprising semantic consistency checking using large language models, structural validation using graph neural networks, completeness assessment using predictive models, and anomaly detection using supervised learning models.

7. The method of claim 1, wherein validating the ontology further comprises:
verifying coverage of domain-specific concepts;
checking consistency of relationships between entities;
identifying gaps in the hierarchical knowledge structure; and
ensuring completeness of entity properties.

8. The method of claim 1, further comprising:
identifying sensitive data within the ontology using a detection algorithm, wherein the identifying comprises:
analyzing metadata of ontological elements to detect potential sensitive data fields;
applying pattern recognition techniques utilizing regular expressions to detect predefined sensitive data patterns;
performing reference data matching using geographical and demographic datasets;
implementing validation algorithms for specific types of sensitive data;
analyzing context surrounding potential sensitive data elements;
classifying detected data elements into corresponding sensitivity categories; and
tagging the identified sensitive data within the hierarchical knowledge structure, wherein the sensitive data comprises at least one of personally identifiable information (PII), payment card industry (PCI) data, and protected health information (PHI).

9. The method of claim 8, further comprising:
implementing access controls for the tagged sensitive data within the ontology;
maintaining an audit trail of access to tagged sensitive data; and
enabling selective masking or encryption of tagged sensitive data during export.

10. The method of claim 1, further comprising:
providing an interface for expert review of the ontology;
receiving refinements to the ontology through the interface; and
updating the ontology based on the received refinements.

11. A system for automatically generating ontologies from domain-specific documents, the system comprising:
a memory storing program instructions that, when executed by a processor, cause the processor to:
receive a plurality of domain-specific documents from one or more data sources;
preprocess the plurality of domain-specific documents to generate normalized documents by performing one or more of:
extracting text from the plurality of domain-specific documents,
removing textual noise from the extracted text, and
standardizing a format of the extracted text;
maintain a task queue configured to enable parallel processing across multiple processing units;
distribute the normalized documents to the task queue;
analyze, by the multiple processing units operating in parallel, content within the normalized documents using natural language processing techniques and generative AI to extract domain-specific entities, entity relationships between the domain-specific entities, and entity properties associated with the domain-specific entities;
generate subject-predicate-object (SPO) formatted data based on the extracted domain-specific entities, the extracted entity relationships, and the extracted entity properties;
construct an ontology by combining the generated SPO formatted data to create a hierarchical knowledge structure;
validate the ontology by verifying completeness of entity relationships and entity properties within the hierarchical knowledge structure; and
export the ontology in a knowledge representation format comprising one of Web Ontology Language (OWL) or Resource Description Framework (RDF).

12. The system of claim 11, wherein preprocessing the plurality of domain-specific documents by implementing a predictive analysis model comprises:
identifying potential gaps in document coverage;
forecasting missing entities based on historical domain patterns;
suggesting modifications to improve ontology completeness; and
flagging potential inconsistencies for expert review.

13. The system of claim 11, wherein analyzing the content using the natural language processing techniques and the generative AI comprises:
implementing a large language model to perform context-aware processing of the normalized documents;
utilizing the large language model to disambiguate terms within the domain-specific documents;
generating semantic relationships between the extracted domain-specific entities using the large language model; and
validating the extracted relationships using contextual analysis.

14. The system of claim 11, wherein analyzing the content to extract domain-specific entities comprises:
Identifying named entities within the normalized documents;
classifying the identified entities into predefined categories; and
establishing hierarchical relationships between the classified entities.

15. The system of claim 11, wherein generating the SPO formatted data comprises:
implementing multiple artificial intelligence models operating in parallel, including: a natural language processing model for basic entity extraction, a large language model for contextual understanding, and a prediction model for relationship validation;
aggregating outputs from the multiple artificial intelligence models; and
resolving conflicts between model outputs using a weighted scoring system.

16. The system of claim 11, wherein validating the ontology comprising implementing an AI-driven validation pipeline comprising semantic consistency checking using large language models, structural validation using graph neural networks, completeness assessment using predictive models, and anomaly detection using supervised learning models.

17. The system of claim 11, wherein the program instructions further cause the processor to:
verify coverage of domain-specific concepts;
check consistency of relationships between entities;
identify gaps in the hierarchical knowledge structure; and
ensure completeness of entity properties.

18. The system of claim 11, wherein the program instructions further cause the processor to:
identify sensitive data within the ontology using a detection algorithm by:
analyzing metadata of ontological elements to detect potential sensitive data fields;
applying pattern recognition techniques utilizing regular expressions to detect predefined sensitive data patterns;
performing reference data matching using geographical and demographic datasets;
implementing validation algorithms for specific types of sensitive data;
analyzing context surrounding potential sensitive data elements;
classifying detected data elements into corresponding sensitivity categories; and
tag the identified sensitive data within the hierarchical knowledge structure, wherein the sensitive data comprises at least one of personally identifiable information (PII), payment card industry (PCI) data, and protected health information (PHI).

19. The system of claim 18, wherein the program instructions cause the processor to:
implement access controls for the tagged sensitive data within the ontology;
maintain an audit trail of access to tagged sensitive data; and
enable selective masking or encryption of tagged sensitive data during export.

20. The system of claim 14, wherein the program instructions further cause the processor to:
provide an interface for expert review of the ontology; receive refinements to the ontology through the interface; and
update the ontology based on the refinements.
